(19) United States
(12) Patent Application Publication
(10) Pub. No.: US 2008/0222308 A1
(43) Pub. Date: Sep. 11, 2008

(54) Wiki groups of an online community

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/715,647

(22) Filed: Mar. 7, 2007

(51) Int. Cl. G06F 15/16

(52) U.S. Cl. 709/245

(57) ABSTRACT

A method, apparatus and system of wiki groups of an online community are disclosed. In one embodiment, a method includes creating a profile of a unregistered user of an online community based on a publicly available data and a registered user provided data, automatically associating the unregistered user to a public group formed of matching interests identified through the publicly available data and as described by the registered user provided data with other registered users in the online community, processing a communication between registered users of the online community and the unregistered user. The method may include associating an address data with the profile based on the publicly available data and an input of the registered user, processing a postage payment and a service payment provided by a member of the public group communicating with the unregistered user through a postal mail communication.

This patent application is being filed simultaneously with an international PCT patent application, titled “WIKI GROUPS OF AN ONLINE COMMUNITY.”

### FIELD OF TECHNOLOGY

This disclosure relates generally to the technical fields of communications and, in one example embodiment, to a method, apparatus, and system of wiki groups of an online community.

### BACKGROUND

An online community (e.g., Facebook®, LinkedIN®, MySpace®, Fatdoor®, Orkut®, Friendster®, etc.) may encourage users to form relationships based on shared interests (e.g., professional interests, recreational interests, social interests, academic interests, political interests, geographic interests and/or cultural interests, etc.).

A registered member (e.g., someone who has signed on to the online community and created a profile) may know information about a person in the physical world, who is not registered in the online community, but who may share similar interests as they or other members of the online community. To allow the person to benefit from the online community, the registered member may ‘invite’ the person to join the online community through an invitation (e.g., an email, an instant message, an SMS, etc). This can be a slow and inefficient process.

For example, John Hanson (e.g., the registered member) of the online community (e.g., Facebook®, LinkedIN®, MySpace®, Fatdoor®, Orkut®, Friendster®, etc.) may know that his friend Sally Short (e.g., the person in the physical world) is interested in golf and who went to the same university as he did (e.g., Arizona State University).

Sally Short may not be a member of the online community. John may invite Sally to join the online community by sending her an email (e.g., the invitation). Sally may take a few days/weeks to respond and may or may not decide to sign up on the online community. Even when she signs up on the online community, Sally may take a few more weeks to join a “golf” group in the online community and enter her educational information. Until she does, Sally may not be able to benefit from the rich networking opportunities in the online community.

Weeks may pass until Sally actually signs up and is able to benefit from the online community. Although John knew Sally went to his university and liked golf even before he invited Sally to join the online community, this information remained offline with John. As such, Sally nor other members of the online community are able to benefit from association, friendship, and networking until and unless she decides to join the online community.

### SUMMARY

A method, apparatus and system of wiki groups of an online community are disclosed. In one aspect, a method includes creating a profile of a unregistered user of an online community based on publicly available data and/or a registered user provided data, automatically associating the unregistered user to a public group (e.g., a professional group, a social group, a recreational group, an interest group, an educational group, a neighborhood group, a cultural group, a ethnic group and/or a geo-spatial group, etc.) formed of matching interests identified through the publicly available data and/or as described by the registered user provided data with other registered users in the online community, and processing a communication between registered users of the online community and the unregistered user.

In addition, the method may include associating an address data with the profile based on the publicly available data and/or an input of the registered user, processing a postage payment and/or a service payment provided by a member of the public group communicating with the unregistered user through a postal mail communication, generating a customized mail-piece having a message from the member of the public group communicating with the unregistered user, and communicating the customized mail-piece to a mail fulfillment center.

The method may further include storing a set of messages between registered users and the unregistered user in a profile associated with the unregistered user, so that the unregistered user can view the messages when the unregistered user joins the online community. Also, the method may include enabling the unregistered user to opt-out of the public group when the unregistered user joins the online community.

Furthermore, the method may include providing in the public group both unregistered members and registered members, and in which any registered user creates the public group whether or not they are a member of the public group, transforming the public group into a private group when the registered user claims the public group, removing certain unregistered members and certain registered members from the private group based on a request of the registered user who claims the public group, and permitting unregistered members to be allocated into the private group for membership consideration by the registered user based on a preference of the registered user claiming the public group.

The method may further include enabling a moderator of the private group to create polls, voting, and elections among registered and/or unregistered members of the private group. The method may yet include integrating the publicly available data by compiling public sources of address, name, phone number, demographic, profession, gender, age, religion, group affiliation, interest affiliation, and/or cultural affiliation data of a person associated with the profile. The method may also include crawling an Internet to discover data associated with the profile based on a neural network algorithm that compares the profile with matching data on the Internet that matches a criterion associated with the profile.

Moreover, the method may include providing a wiki interface in the profile of the unregistered user such that any registered user can update, add, and/or modify group allocations, descriptions, interests, and characteristics of a person associated with the profile until the person associated with the profile claims the profile and marks the profile as being private. The method may also include forming a neighborhood group between the unregistered user, a registered user, and other users through a selection tool (e.g., a lasso tool, a drag and drop tool, and a point-and-click-to-add tool, etc.) in a geo-spatial environment such that those profiles that are selected may be invited into the neighborhood group, and/or providing a notification that a new neighborhood group has been formed in their geographic area to neighbors adjacent to the selected area using the selection tool.

The method may further include publicly displaying membership numbers in public groups and/or private groups of the online community such that it may be visually indicated as to how many members are registered members and how many members are unregistered members. The method may also include a machine-readable medium embodying a set of instructions that, when executed by a machine, causes the machine to perform the method.

In another aspect, a system includes a grouping module to create associations between users and non-users of a social network and to facilitate communications between the users and the non-users (e.g., the non-users are contactable by users of the social network through a degree of separation inferred based on the user who populated a profile associated with the non-user through a wiki module) based on a location based data of the non-users, and a wiki module to populate the location based data of the non-users until the non-users claim their profiles in the social network.

Furthermore, the system may include a search module to provide responses to group search queries of users and non-users of the social network, and to automatically create a group based on a tag provided through the wiki module when there are no members of the group prior to the tag by a user on a non-user's profile.

In yet another aspect, a method includes providing in a public group both unregistered members and registered members, and in which any registered user creates the public group whether or not they are a member of the public group, transforming the public group into a private group when the registered user claims the public group, and removing certain unregistered members and certain registered members from the private group based on a request of the registered user who claims the public group.

In addition, the method may include permitting unregistered members to be allocated into the private group for membership consideration by the registered user based on a preference of the registered user claiming the public group. The method may further include providing a wiki interface in a profile of an unregistered user such that any registered user can update, add, and modify group allocations, descriptions, interests, and characteristics of a person associated with the profile until the person associated with the profile claims the profile and marks the profile as being private.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows:

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a central module communicating with an online community and a public community through a network, according to one embodiment.

FIG. 2 is an exploded view of a wiki module of FIG. 1, according to one embodiment.

FIG. 3 is a user interface view of the wiki module of FIG. 1, according to one embodiment.

FIG. 4 is a user interface view of a map module of FIG. 1, according to one embodiment.

FIG. 5 is a user interface view of a profile search, according to one embodiment.

FIG. 6 is a user interface view of claiming a wiki profile, according to one embodiment.

FIG. 7 is a table view of data referenced by the grouping module of FIG. 1.

FIG. 8 is a diagrammatic system view of a data processing system in which any of the embodiments disclosed herein may be performed, according to one embodiment.

FIG. 9A is a process flow of creating a profile of an unregistered user of an online community, according to one embodiment.

FIG. 9B is a continuation of the process flow of FIG. 9A illustrating additional processes, according to one embodiment.

FIG. 9C is a continuation process flow of FIG. 9B illustrating additional processes, according to one embodiment.

FIG. 10 is a process flow of a registered user to create a public group, according to one embodiment.

Other features of the present invention embodiments will be apparent from the accompanying drawings and from the detailed description that follows:

### DETAILED DESCRIPTION

A method, apparatus and system of wiki groups of an online community are disclosed. In the following description, for the purposes of explanation, numerous specific details are set forth in order to provide a thorough understanding of the various embodiments. It will be evident, however to one skilled in the art that the various embodiments may be practiced without these specific details.

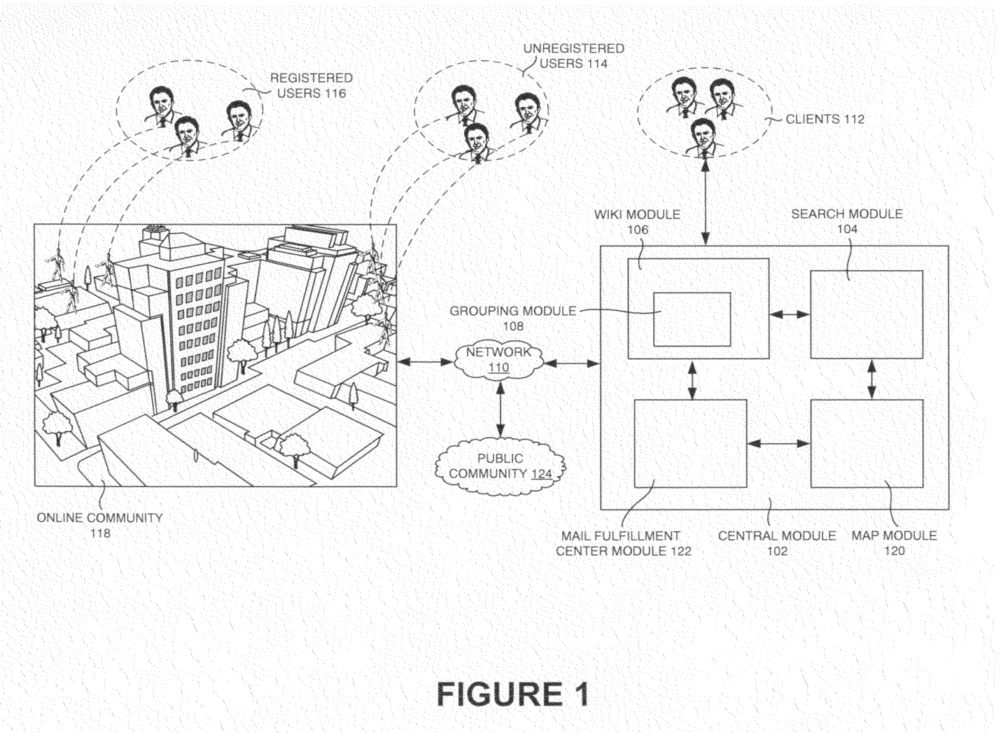

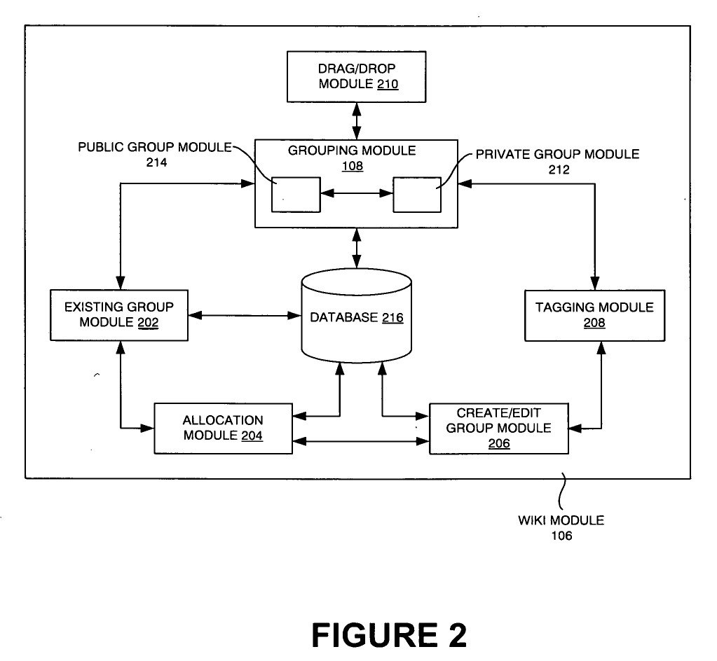

In one embodiment, a method includes creating a profile of a unregistered user (e.g., the unregistered user 114 of FIG. 1) of an online community (e.g., the online community 118 of FIG. 1) based on publicly available data and/or a registered user provided data, automatically associating the unregistered user to a public group (e.g., the public group module 214 of FIG. 2) formed of matching interests identified through the publicly available data and as described by the registered user provided data with other registered users in the online community, and/or processing a communication between registered users of the online community and the unregistered user.

In another embodiment, a system includes a grouping module (e.g., the grouping module 108 of FIG. 1) to create associations between users and non-users of a social network and to facilitate communications between the users and the non-users based on a location based data of the non-users, and a wiki module (e.g., the wiki module 106 of FIG. 1) to populate the location based data of the non-users until the non-users claim their profiles in the social network.

In yet another embodiment, a method includes providing in a public group both unregistered members and registered members, and in which any registered user creates the public group whether or not they are a member of the public group, transforming the public group into a private group (e.g., a private group module 212 of FIG. 2) when the registered user claims the public group, and removing certain unregistered members and certain registered members from the private group based on a request of the registered user who claims the public group.

FIG. 1 is a system view of a central module 102 communicating with an online community 118 and a public community 124 through a network 110, according to one embodiment. Particularly, FIG. 1 illustrates the central module 102, a search module 104, a wiki module 106, a grouping module 108, the network 110, the clients 112, an unregistered user 114, a registered user 116, the online community 118, a map module 120, a mail fulfillment center module 122 and the public community 124, according to one embodiment.

The central module 102 may facilitate communication between the users and non-user of the geo-spatial social network based on the publicly available data. The search module 104 may create the group in the online community based on a tag provided through the wiki module 106. The wiki module 106 may populate the location data associated with the non-users who have not claimed their profile in the geo-spatial network.

The grouping module 108 may create associations between users and/or non-users of a social network and/or may facilitate communication between the users and the non-users based on the location based data of the non users. The network 110 may be associated with the communication between the central module 102, the online community 118 and the public community 124 for storing and/or retrieving the information and/or volume of data. The clients 112 may be the users in the wiki group, who may be involved in communicating with the central module 102. The unregistered users 114 may be the non-users who may not have claimed their profiles in the wiki group and/or may be involved in communicating with the online community 118.

The registered users 116 may be the users who may have claimed their profiles in the social network and/or may be involved in creating the public group in the online community 118. The online community 118 may include users and non-users of the social network and may consist of the public and private groups created by the registered users 116. The map module 120 may include maps and may graphically visualize (e.g., in a map), physical locations of the users and non-users in the neighborhood. In addition, the map module 120 may display the profile associated with the users in the online community 118.

The mail fulfillment center module 122 may be a letter box, a slot for incoming mail and/or e-mail that may convey messages for communications between the registered and unregistered users of the online community. The public community 124 may refer to the people living in a community, a neighborhood, a state and/or a nation, etc. The public community may represent an aggregation of people in a network that may or may not be regulated.

In the example embodiment illustrated in FIG. 1, the central module 102 communicates with the online community 118 and the public community 124 through the network 110. The unregistered users 114 and registered users 116 communicate with the online community 118.

The profile of the unregistered user 114 of the online community 118 may be created based on publicly available data and/or the registered user provided data. Moreover, the communication may be processed between registered users 116 of the online community 118 and the unregistered users 114. Also, the address data with the profile may be associated, based on the publicly available data and/or the input of the registered user 116.

In addition, the postage payment and/or the service payment provided by the member of the public group communicating with the registered user 116 may be posted through the postal mail communication. Furthermore, the customized mail-piece having a message may be generated from the member of the public group communicating with the unregistered user 114. Also, the customized mail-piece may be communicated to a mailbox fulfillment center (e.g., the mail fulfillment center module 122 of FIG. 1). Moreover, a set of messages may be stored between registered users 116 and the unregistered user 114 in the profile associated with the unregistered user 114, so that the unregistered user 114 can view the messages when the unregistered user 114 joins the online community 118.

The grouping module 108 may process (e.g., create) associations between users and non-users of a social network and/or facilitate communications between the users and the non-users based on a location based data of the non-users. The wiki module 106 may populate the location based data of the non-users until the non-users claim their profiles in the social network. The search module 104 may provide responses to group search queries of users and/or non-users of the social network, and/or automatically create a group based on a tag provided through the wiki module when there are no members of the group prior to the tag by a user on a non-user's profile. Moreover, the non-users may be contactable by users of the social network through a degree of separation inferred based on the user who populated a profile associated with the non-user through the wiki module 106.

FIG. 2 is an exploded view of the wiki module 106 of FIG. 1, according to one embodiment. Particularly, FIG. 2 illustrates the grouping module 108, an existing group module 202, an allocation module 204, a create/edit group module 206, a tagging module 208, a drag/drop module 210, a private group module 212, a public group module 214 and a database 216, according to one embodiment.

The existing group module 202 may represent (a) group(s) created by the registered users of the online community which may already exist in the database 216. The allocation module 204 may allocate the wiki profile selected by the users to the particular group(s) based on the claimed users' request.

The create and edit group module 206 may enable the users to update, add and modify the group allocations associated with the profile until the person associated with the profile claims the profile and marks the profile as being private. The tagging module 208 may automatically tag the uploaded wiki profiles in the geo-spatial environment based on the location and/or information of the users. The drag and drop module 210 may drag and drop the wiki profiles requested by the users. The private group module 212 may enable the moderator of the private groups to create polls, voting, and/or elections among the registered and unregistered members of the private group. The public group module 214 may enable the registered users to create the public group and may enable the unregistered users to opt-out of the public group when the unregistered users join the online community. The database 216 may hold records and/or information of claimed and unclaimed profiles along with the location data, personal data, etc. in a geo-spatial environment.

In the example embodiment illustrated in FIG. 2, the database 216 may communicate with the existing group module 202, the allocation module 204, the create/edit group module 206, and/or the grouping module 108 to keep the record of wiki profiles and/or wiki groups associated with the registered users 116 and the unregistered users 114. In addition, the grouping module 108 may include the public group module 214 and the private group module 212. The grouping module 108 may further communicate with the drag/drop module 210 and the tagging module 208.

The unregistered users (e.g., the unregistered users 114 of FIG. 1) may be automatically associated to the public group, (e.g., the public group module 214 of FIG. 2) formed of matching interests identified through the publicly available data and/or as described by the registered users provided data with other registered users in the online community (e.g., the online community 118 of FIG. 1). Moreover, the unregistered users may be enabled to opt-out of the public group, when the unregistered users join the online community. Furthermore, both unregistered members and registered members may be provided in the public group (e.g., any registered user may create the public group whether or not they are a member of the public group).

In addition, the public group may be transform into a private group (e.g., the private group module 212 of FIG. 2) when the registered users claim the public group. Furthermore, certain unregistered members and certain registered members from the private group may be removed, based on the request of the registered users who claim the public group. Also, unregistered members who may be allocated into the private group for membership consideration may be permitted by the registered users based on the preference of the registered users claiming the public group. Moreover, the moderator of the private group may be enabled to create polls, voting, elections among registered and unregistered members of the private group.

The publicly available data may be integrated by compiling public sources of address, name, phone number, demography, profession, gender, age religion, group affiliation, interest affiliation and/or cultural affiliation data of the person associated with the profile. Furthermore, the internet may be crawled to discover data associated with the profile based on a neural network algorithm that compares the profile with matching data on the internet that matches a criterion associated with the profile. Also, wiki interface in the profile of the unregistered user may be provided such that any registered users can update, add, and/or modify group allocation, descriptions, interests, and/or characteristics of the person associated with the profile until the person associated with the profile claims the profile and/or marks the profile as being private.

The neighborhood group may be formed between the unregistered users, the registered users, and other users through a selection tool (e.g., a lasso tool, a drag and drop tool, and/or a point-and-click-to-add tool) in the geo-spatial environment such that those profiles that are selected are invited into the neighborhood group. In addition, notification may be provided that the new neighborhood group has been formed in their geographic area to neighbors, adjacent to the selected area using the selection tool.

Furthermore, the membership numbers in the public groups and/or private groups of the online community may be publicly displayed such that, it is visually indicated as to how many members are registered members and how many members are unregistered members. The grouping module (e.g., the grouping module 108 of FIG. 1) may create associations between users and non-users of a social network and/or facilitate communications between the users and the non-users based on a location based data of the non-users.

The public group (e.g., the public group module 214 of FIG. 2) may be provided both unregistered members and registered members. Any registered users may create the public group whether or not they are a member of the public group. In addition, the public group may be transformed into the private group when the registered users claim the public group.

Furthermore, certain unregistered members and certain registered members may be removed from the private group based on a request of the registered users who claim the public group. Also, unregistered members to be allocated into the private group may be permitted for membership consideration by the registered users based on the preference of the registered users claiming the public group. Moreover, the wiki interface may be provided in the profile of an unregistered user such that any unregistered user can update, add, and/or modify group allocations, descriptions, interests, and characteristics of a person associated with the profile until the person associated with profile claims, the profile and/or marks the profile as being private.

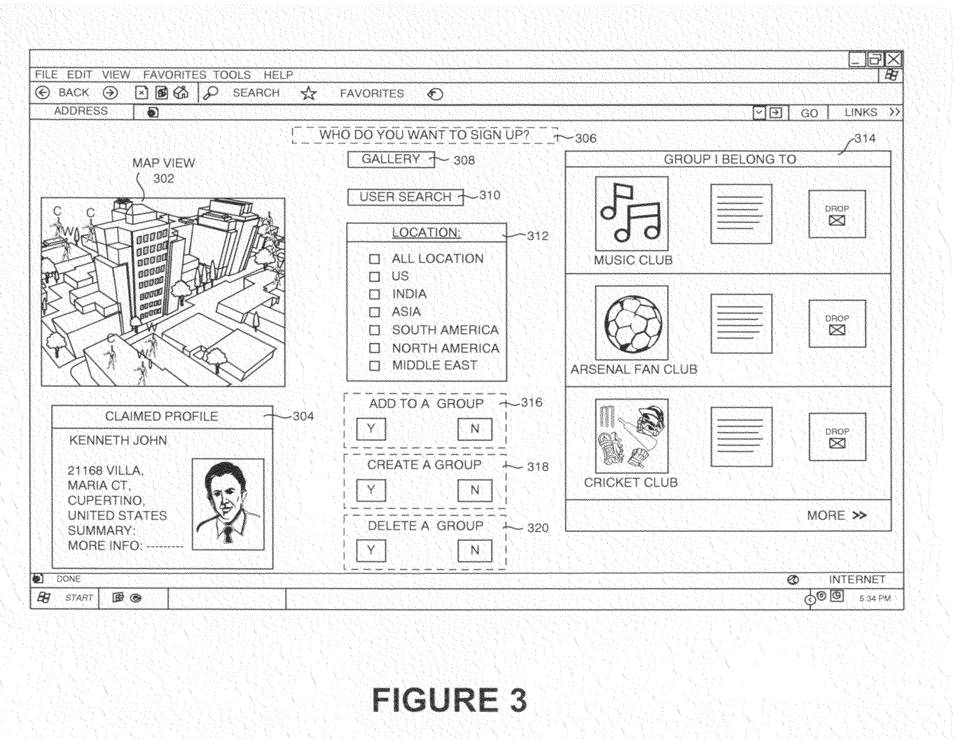

FIG. 3 is a user interface view of the wiki module 106 of FIG. 1, according to one embodiment. Particularly, FIG. 3 illustrates a map view 302, a claimed profile 304, a who do you want to sign up? option 306, a gallery 308, a user search 310, a location 312, groups I belong to 314, an add to a group option 316, a create a group option 318 and a delete a group option 320, according to one embodiment.

The map view 302 may render the geo-spatial environment concurrently representing distance, neighboring places and/or profiles indicating claimed and/or wiki profiles. The claimed profile 304 may enable the user to view the profile information of any user who has have claimed his/her profile. The who do you want to sign up? option 306 may query the registered users to add the users and/or non-users of the online community of a particular group. The gallery 308 may contain a list of registered user profiles and unregistered user profiles. The user search 310 may permit the moderator of the claimed profile to search any user based on the location, name, age, ethnicity, and/or geographic location, etc. The location 312 may be used to select the location (e.g., US, India, Asia, etc.) of any profile in the neighborhood of the geo-spatial environment. The groups I belong to field 314 may display all the groups the user belongs to. The add to a group option 316 may enable the user of the online community to add people to the group by dragging and dropping and/or lassoing the wiki profiles in the online community. The create a group option 318 may enable the user to create new grousp in the online community and/or may allow the users to invite the other users to join the newly created group. The delete a group option 320 may permit the users to delete the group created by him/her.

In the example embodiment illustrated in FIG. 3, the user interface of the wiki module 106 may enable the user to visualize a 3D-map view and a claimed profile associated with the user of the online community. The user interface view may also allow the user to sign up people in the neighborhood on the online community. The user interface view of the wiki module 106 may enable the user to create and/or delete the groups through the create a group option 318 and the delete a group option 320.

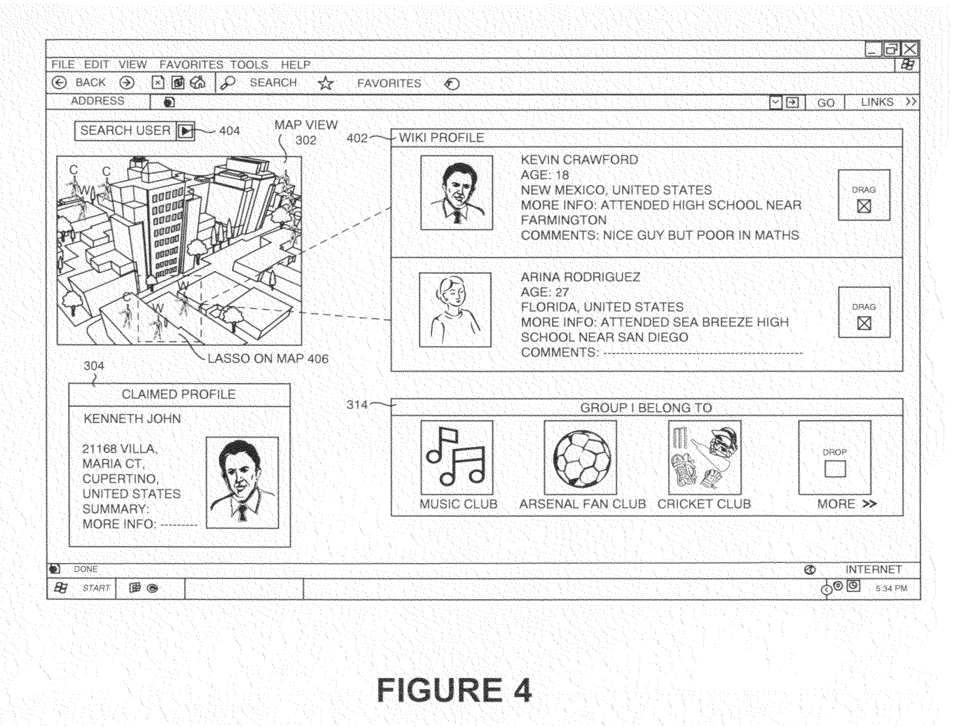

FIG. 4 is a user interface view of the map module 120 of FIG. 1, according to one embodiment. Particularly, FIG. 4 illustrates a wiki profile 402, a search user field 404, a lasso on map 406, the map view 302, the claimed profile 304, and the group I belong to 314, according to one embodiment.

The wiki profile option 402 may display the profile information created by dragging and dropping the profile associated with the users into a particular group from the map. The option search user 404 may enable the users to search people in the neighborhood through search query. The lasso on map option 406 may enable the user to group-move the people in the neighborhood through lassoing on the map.

In the example embodiment illustrated in FIG. 4, the user interface view of the map module 120 may enable the users to add people in the neighborhood to a particular group by dragging and dropping and/or lassoing. Also, the users can search the people in the neighborhood of the online community (e.g., through search queries).

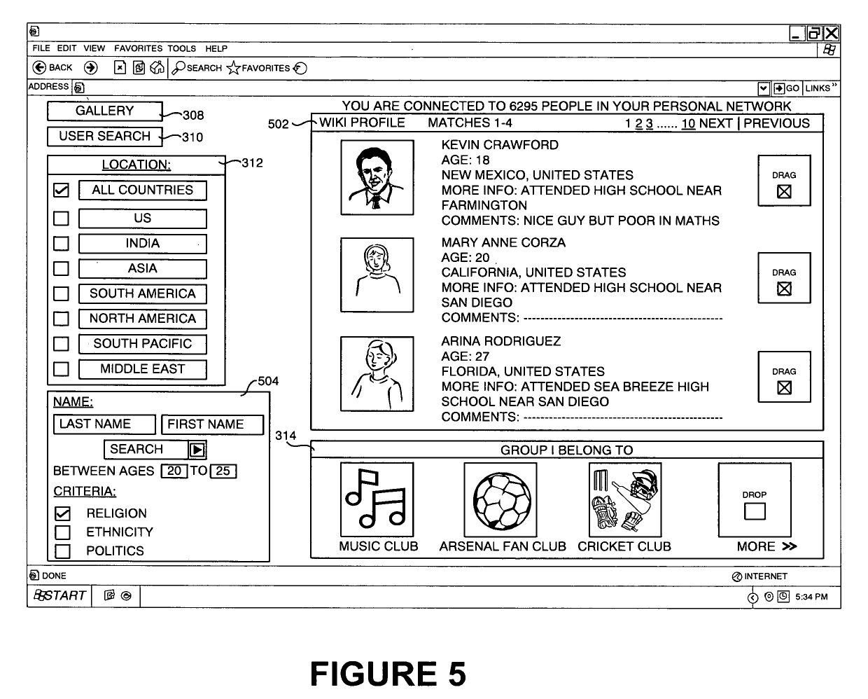

FIG. 5 is a user interface view of a profile search, according to one embodiment. Particularly, FIG. 5 illustrates a search result 502, a search query option 504, the gallery 308, the user search field 310, the location 312, the group I belong to view 314, according to one embodiment.

The search result 502 may display the profile information associated with the search query requested by the users of the online community. The search query option 504 may enable the users to enter the search query associated with the people in the neighborhood.

In the example embodiment illustrated in FIG. 5, the user interface view of the search module 104 may enable the users to search for people in the neighborhood of the online community through the search query associated with the publicly available data.

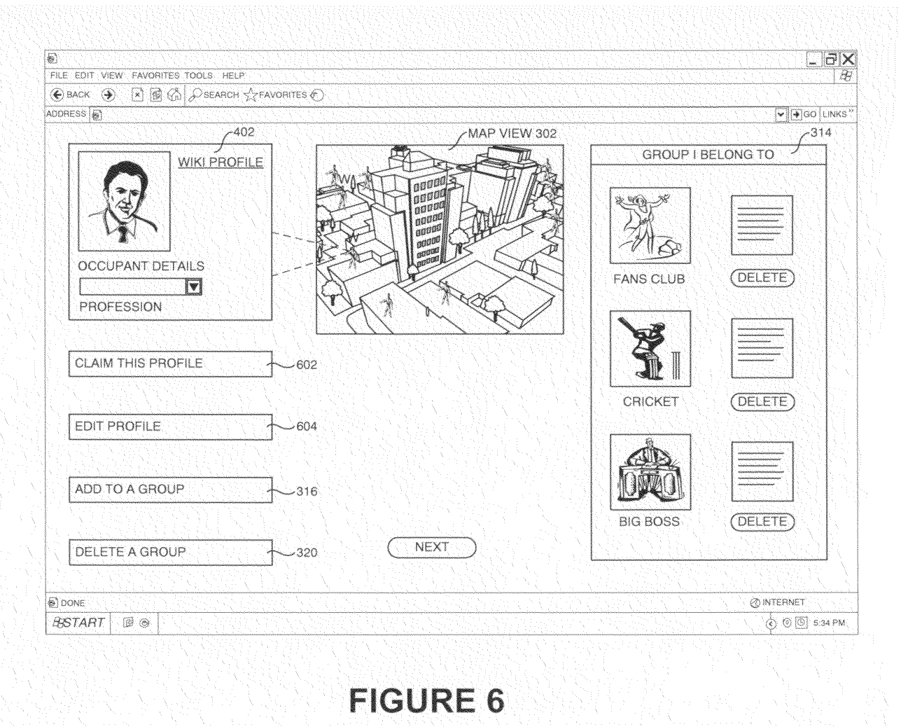

FIG. 6 is a user interface view of claiming a wiki profile, according to one embodiment. Particularly, FIG. 6 illustrates a claim this profile option 602, an edit profile option 604, the map view 302, the group I belong to 314, the add to a group option 316, the delete a group option 320 and the wiki profile 402, according to one embodiment.

The claim this profile option 602 may enable the user to claim the profile created by the registered user of the online community. The edit profile option 604 may allow the user of the claimed profile to update, modify and/or create the contents linked to the personal information.

In the example embodiment illustrated in FIG. 6, the user interface of claiming the wiki profile may enable users to claim the wiki profile created by the registered users. The user interface of claiming the wiki profile may also enable the users to edit and/or update the claimed profile.

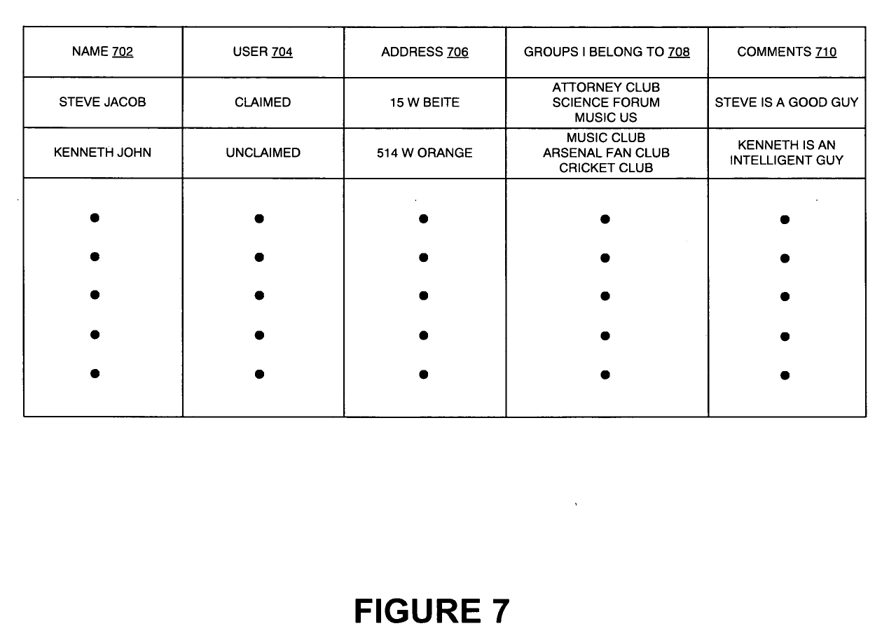

FIG. 7 is a table view of data referenced by the grouping module 108 of FIG. 1, according to one embodiment. Particularly, FIG. 7 illustrates a name 702, a user 704, an address 706, a group I belong to field 708 and comments 710, according to one embodiment.

The name 702 may display the name of the users of the geo-spatial environment. The user 704 may be any kind of user (e.g., a claimed user or an unclaimed user) in the geo-spatial environment. The address 706 may reference information associated with address data of users in a geo-spatial environment. The group I belong to field 708 may display all the groups the users belong to. The comments 710 may display the remarks made by the registered users to other users of the online community.

In the example embodiment illustrated in FIG. 7, the name field 702 displays “Steve Jacob” in the first row and “Kenneth John” in the second row of the name 702 column of the table view. The user field 704 displays “claimed” in the first row and “unclaimed” in the second row of the user 704 column of the table view. The address field 706 displays “15 w beite” and 514 w orange in the address 706 column. The groups I belong to field 708 displays “attorney club, science forum, music us” and music club, arsenal fan club, cricket club” in the groups I belong to 708 column. The comments field 710 displays “steve is a good guy” and “Kenneth is an intelligent guy” in the comments column 710.

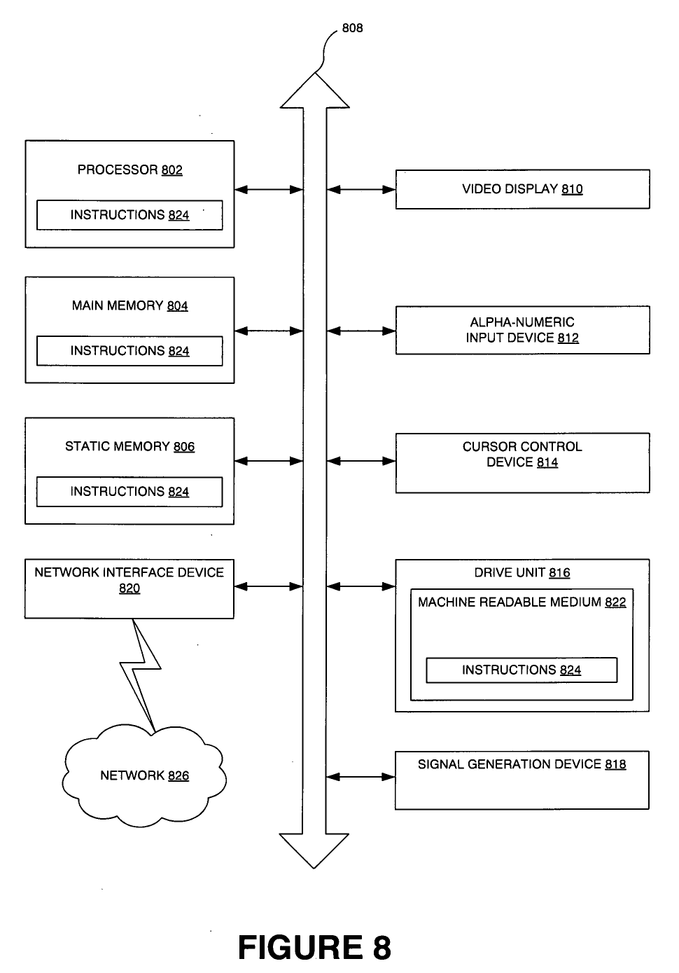

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein may be performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system. The static memory 806 may be a hard drive, a flash drive, and/or other memory information associated with the data processing system.

The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one/or more operations disclosed herein.

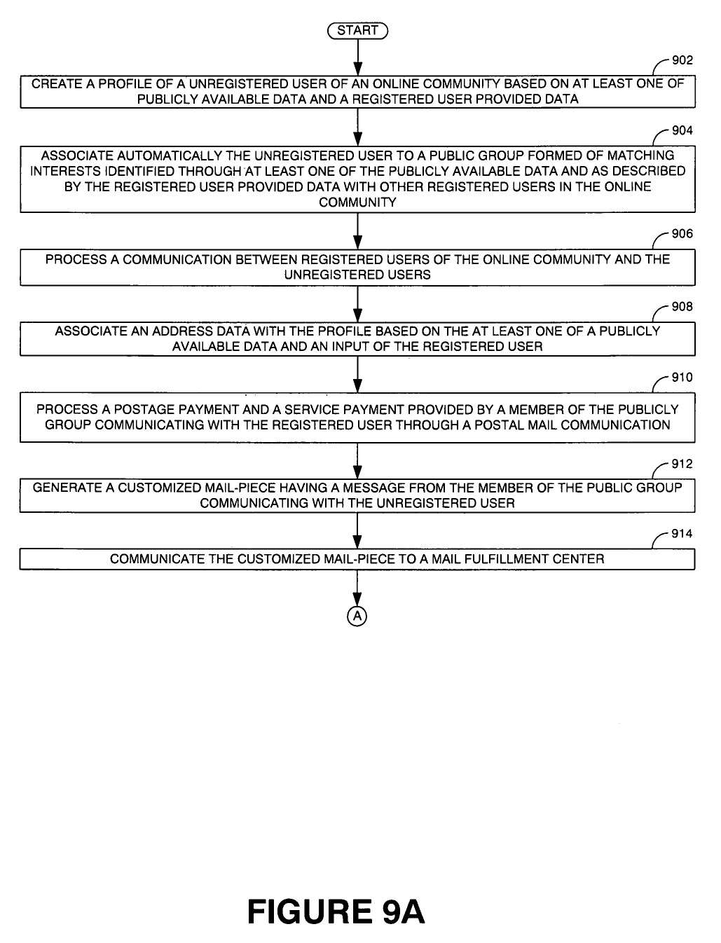

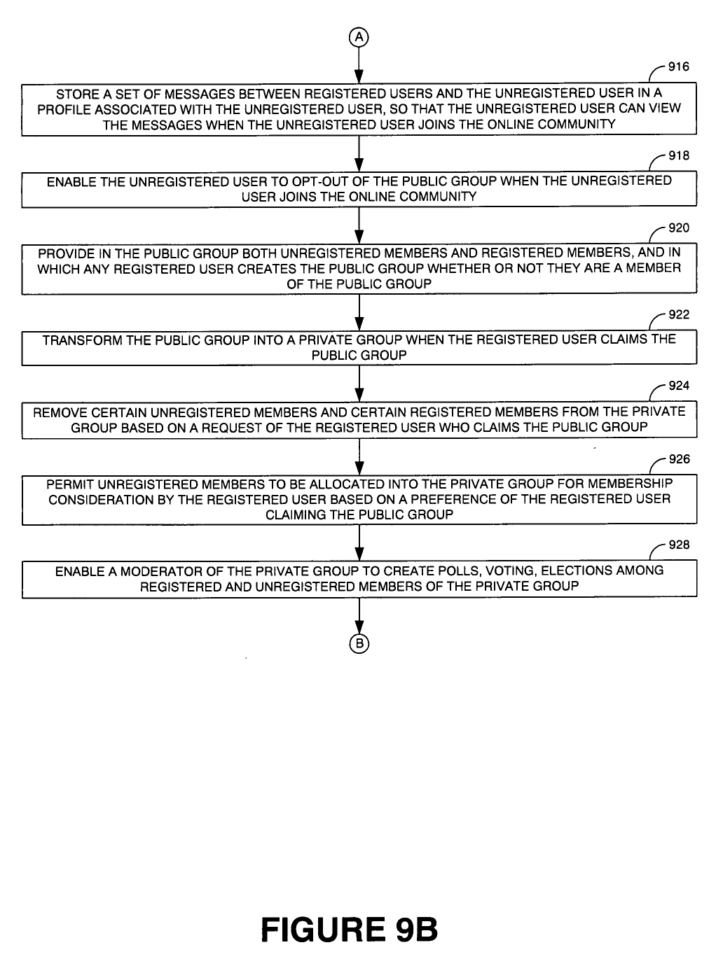

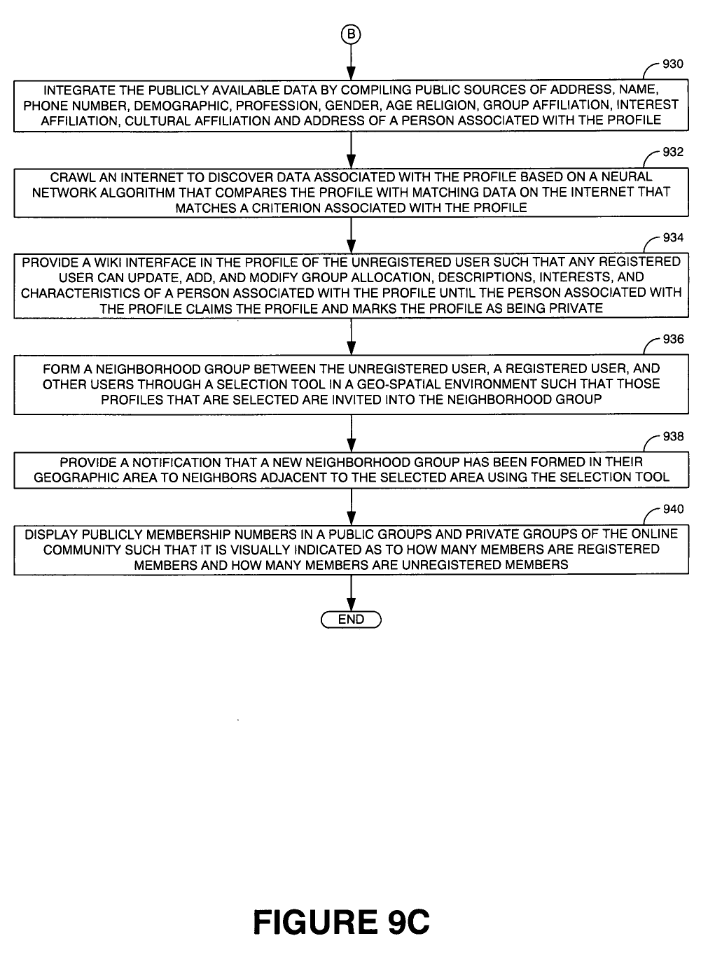

FIG. 9A is a process flow of creating a profile of an unregistered user of an online community, according to one embodiment. In operation 902, a profile of the unregistered user (e.g., the unregistered user 114 of FIG. 1) of an online community (e.g., the online community 118 of FIG. 1) may be created based on publicly available data and/or a registered user provided data. In operation 904, the unregistered user may be automatically associated to a public group (e.g., the public group module 214 of FIG. 2) formed of matching interests identified through the publicly available data and/or as described by the registered user provided data with other registered users in the online community. In operation 906, a communication may be processed between registered users of the online community and/or the unregistered users. In operation 908, an address data may be associated with the profile based on a publicly available data and/or an input of the registered users. In operation 910, a postage payment and/or a service payment provided by a member of the publicly group communicating with the registered users through a postal mail communication may be processed. In operation 912, a customized mail-piece having a message from the member of the public group communicating with the unregistered user may be generated. In operation 914, the customized mail-piece may be communicated to a mail fulfillment center (e.g., the mail fulfillment center module 122 of FIG. 1).

FIG. 9B is a continuation of the process flow of FIG. 9A illustrating additional processes, according to one embodiment. In operation 916, a set of messages between registered users and/or the unregistered user may be stored in a profile associated with the unregistered user, so that the unregistered users can view the messages when the unregistered users join the online community. In operation 918, the unregistered users may be enabled to opt-out of the public group when the unregistered users join the online community. In operation 920, the public group may be provided both unregistered members and registered members, and in which any registered user may create the public group whether or not they are a member of the public group. In operation 922, the public group may be transformed into a private group (e.g., a private group module 212 of FIG. 2) when the registered users claim the public group. In operation 924, certain unregistered members and certain registered members may be removed from the private group based on a request of the registered user who claims the public group. In operation 926, unregistered members may be permitted to be allocated into the private group for membership consideration by the registered users based on a preference of the registered users claiming the public group. In operation 928, a moderator of the private group may be enabled to create polls, voting, and/or elections among registered and unregistered members of the private group.

FIG. 9C is a continuation process flow of FIG. 9B illustrating additional processes, according to one embodiment. In operation 930, the publicly available data may be integrated by compiling public sources of address, name, phone number, demographic, profession, gender, age religion, group affiliation, interest affiliation, and/or cultural affiliation data of a person associated with the profile. In operation 932, an internet may be crawled to discover data associated with the profile based on a neural network algorithm that compares the profile with matching data on the internet that matches a criterion associated with the profile. In operation 934, a wiki interface may be provided in the profile of the unregistered users such that any registered users can update, add and/or modify group allocation, descriptions, interests, and/or characteristics of a person associated with the profile until the person associated with the profile claims the profile and marks the profile as being private. In operation 936, a neighborhood group may be formed between the unregistered users, the registered users, and/or other users through a selection tool in a geo-spatial environment such that those profiles that are selected may be invited into the neighborhood group. In operation 938, a notification that a new neighborhood group has been formed in their geographic area may be provided to neighbors adjacent to the selected area using the selection tool. In operation 940, membership numbers in a public groups and private groups of the online community may be publicly displayed such that it may be visually indicated as to how many members are registered members and how many members are unregistered members.

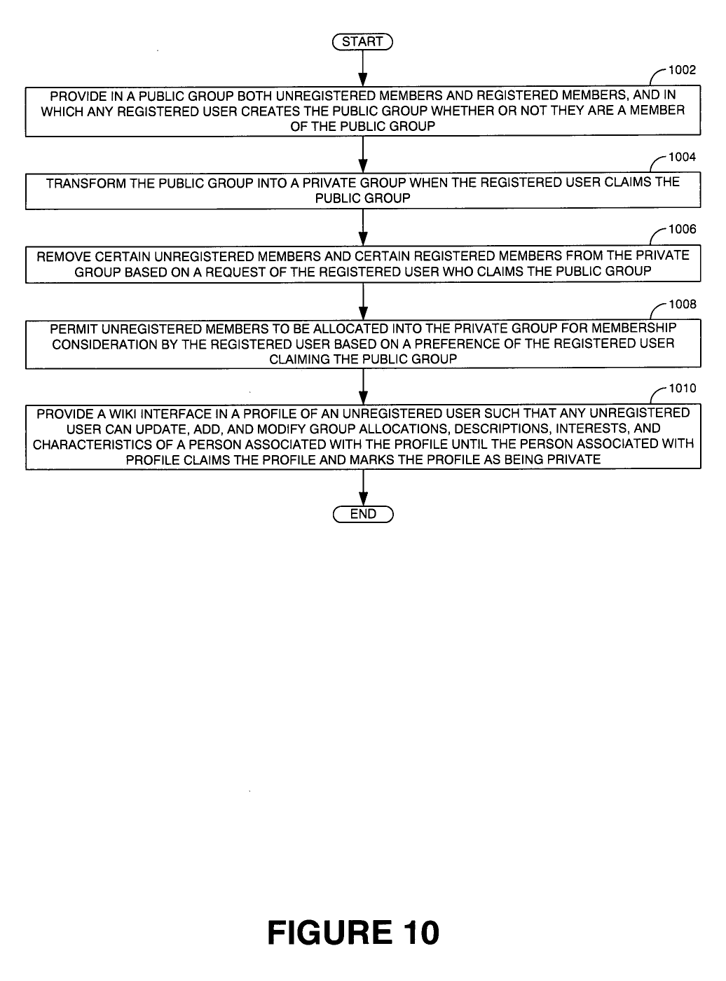

FIG. 10 is a process flow of a registered user to create a public group, according to one embodiment. In operation 1002, a public group may be provided both unregistered members and registered members, and in which any registered users create the public group whether or not they are a member of the public group. In operation 1004, the public group may be transformed into a private group when the registered user claims the public group. In operation 1006, certain unregistered members and certain registered members may be removed from the private group based on a request of the registered user who claims the public group. In operation 1008, unregistered members may be permitted to be allocated into the private group for membership consideration by the registered users based on a preference of the registered user claiming the public group. In operation 1010, a wiki interface may be provided in a profile of an unregistered user such that any unregistered users can update, add and/or modify group allocations, descriptions, interests, and/or characteristics of a person associated with the profile until the person associated with profile claims the profile, and/or marks the profile as being private.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., application specific integrated ASIC circuitry and/or in Digital Signal; Processor DSP circuitry). For example, the central module 102, the search module 104, the wiki module 106, the grouping module 108, the map module 120, the mail fulfillment center module 122, the existing group module 202, the allocation module 204, the create/edit group module 206, the tagging module 208, the drag/drop module 210, the private group module 212 and the public group module 214 of FIGS. 1-2 may be embodied through the central circuit, the search circuit, the wiki circuit, the grouping circuit, the map circuit, the mailbox fulfillment center circuit, the existing group circuit, the allocation circuit, the create/edit group circuit, the tagging circuit, the drag/drop circuit, the private group circuit and the public group circuit, using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
creating a profile of a unregistered user of an online community based on at least one of publicly available data and a registered user provided data;
automatically associating the unregistered user to a public group formed of matching interests identified through at least one of the publicly available data and as described by the registered user provided data with other registered users in the online community; and
processing a communication between registered users of the online community and the unregistered user.

2. The method of claim 1 further comprising:
associating an address data with the profile based on the at least one of a publicly available data and an input of the registered user; and
processing a postage payment and a service payment provided by a member of the public group communicating with the unregistered user through a postal mail communication;
generating a customized mail-piece having a message from the member of the public group communicating with the unregistered user; and
communicating the customized mail-piece to a mail fulfillment center.

3. The method of claim 1 further comprising storing a set of messages between registered users and the unregistered user in a profile associated with the unregistered user, so that the unregistered user can view the messages when the unregistered user joins the online community.

4. The method of claim 3 further comprising enabling the unregistered user to opt-out of the public group when the unregistered user joins the online community.

5. The method of claim 3 further comprising:
providing in the public group both unregistered members and registered members, and in which any registered user creates the public group whether or not they are a member of the public group;
transforming the public group into a private group when the registered user claims the public group;
removing certain unregistered members and certain registered members from the private group based on a request of the registered user who claims the public group; and
permitting unregistered members to be allocated into the private group for membership consideration by the registered user based on a preference of the registered user claiming the public group.

6. The method of claim 1 further comprising enabling a moderator of the private group to create polls, voting, and elections among registered and unregistered members of the private group.

7. The method of claim 1 further comprising integrating the publicly available data by compiling public sources of address, name, phone number, demographic, profession, gender, age, religion, group affiliation, interest affiliation and cultural affiliation data of a person associated with the profile.

8. The method of claim 7 further comprising crawling an Internet to discover data associated with the profile based on a neural network algorithm that compares the profile with matching data on the Internet that matches a criterion associated with the profile.

9. The method of claim 1 wherein the public group is at least one of a professional group, a social group, a recreational group, an interest group, an educational group, a neighborhood group, a cultural group, a ethnic group and a geo-spatial group.

10. The method of claim 1 further comprising providing a wiki interface in the profile of the unregistered user such that any registered user can update, add, and modify group allocations, descriptions, interests, and characteristics of a person associated with the profile until the person associated with the profile claims the profile and marks the profile as being private.

11. The method of claim 1 further comprising forming a neighborhood group between the unregistered user, a registered user, and other users through a selection tool in a geo-spatial environment such that those profiles that are selected are invited into the neighborhood group, and wherein the selection tool is at least one of a lasso tool, a drag and drop tool, and a point-and-click-to-add tool.

12. The method of claim 11 further comprising providing a notification that a new neighborhood group has been formed in their geographic area to neighbors adjacent to the selected area using the selection tool.

13. The method of claim 11 further comprising publicly displaying membership numbers in public groups and private groups of the online community such that it is visually indicated as to how many members are registered members and how many members are unregistered members.

14. The method of claim 1 in a form of a machine-readable medium embodying a set of instructions that, when executed by a machine, causes the machine to perform the method of claim 1.

15. A system comprising:
a grouping module to create associations between users and non-users of a social network and to facilitate communications between the users and the non-users based on a location based data of the non-users; and
a wiki module to populate the location based data of the non-users until the non-users claim their profiles in the social network.

16. The system of claim 15 further comprising a search module to provide responses to group search queries of users and non-users of the social network, and to automatically create a group based on a tag provided through the wiki module when there are no members of the group prior to the tag by a user on a non-user's profile.

17. The system of claim 15 wherein the non-users are contactable by users of the social network through a degree of separation inferred based on the user who populated a profile associated with the non-user through the wiki module.

18. A method comprising:
providing in a public group both unregistered members and registered members, and in which any registered user creates the public group whether or not they are a member of the public group;
transforming the public group into a private group when the registered user claims the public group; and
removing certain unregistered members and certain registered members from the private group based on a request of the registered user who claims the public group.

19. The method of claim 18 further comprising permitting unregistered members to be allocated into the private group for membership consideration by the registered user based on a preference of the registered user claiming the public group.

20. The method of claim 19 further comprising providing a wiki interface in a profile of an unregistered user such that any registered user can update, add, and modify group allocations, descriptions, interests, and characteristics of a person associated with the profile until the person associated with the profile claims the profile and marks the profile as being private.
